(19) United States
(12) Patent Application Publication
(10) Pub. No.: US 2024/0116142 A1
(43) Pub. Date: Apr. 11, 2024

(54) WELDING APPARATUS

(71) Applicant: SAMUEL, SON & CO. (USA) INC., Woodridge, IL (US)

(72) Inventor: CLINTON HOY, Tucson, AZ (US)

(73) Assignee: SAMUEL, SON & CO. (USA) INC., Woodridge, IL (US)

(21) Appl. No.: 17/963,638

(22) Filed: Oct. 11, 2022

(51) Int. Cl. B23K 37/02; B23K 31/02

(52) U.S. Cl. CPC B23K 37/02; B23K 31/02

(57) ABSTRACT

An apparatus can include a support, and a base member coupled with the support at a first end of the base member, the base member extending from the support. The apparatus can include an arm coupled with the base member at a second end of the base member, the arm extending from the base member to fit within an opening in a vessel. The apparatus can also include a welding head coupled with the arm, the welding head to weld a welding interface at an interior surface of the vessel.

### BACKGROUND

Vessels can be used to store and transfer gases or liquids, for example at pressures that are different than ambient pressure. The vessels can be serviced, maintained, or otherwise repaired.

### SUMMARY

An apparatus for remote welding of an interface at an interior surface of a vessel. The apparatus can include a support and a base member coupled with the support, the base member extending from the support. The apparatus can also include an arm coupled with the base member, the arm extending from the base member to fit within an opening in a vessel, and a welding head coupled with the arm, the welding head to weld a welding interface at an interior surface of the vessel. In this example, the apparatus provides access to a welding environment at the interior of a vessel (e.g., via an opening in the vessel), which would otherwise be difficult to access. The arm can rotatably couple the base member, the arm to rotate about an axis relative to the base member. In this example, the apparatus provides increased maneuverability within a vessel, for example to facilitate performing a welding operation at an interior surface of the vessel. The apparatus can include a computing device coupled with the arm, the computing device to capture an image of a welding interface, the welding head, or the vessel. In this example, the apparatus provides increased visibility to a welding environment at an interior of the vessel. The apparatus can include a remote computing device communicably coupled with the welding head or the computing device, the remote computing device to control the welding head to weld the welding interface or the computing device to capture an image of the welding interface. In this example, the apparatus provides remote control and visualization of the apparatus, for example to facilitate visualization, monitoring, or control of a welding operation at an interior surface of a vessel from a remote device.

At least one aspect is directed to a welding apparatus. The welding apparatus can include a support, and a base member coupled with the support at a first end of the base member, the base member extending from the support. The welding apparatus can include an arm coupled with the base member at a second end of the base member, the arm extending from the base member to fit within an opening in a vessel. The welding apparatus can also include a welding head coupled with the arm, the welding head to weld a welding interface at an interior surface of the vessel.

At least one aspect is directed to a method of welding a remote object. The method can include providing a support and providing a base member coupled with the support at a first end of the base member, the base member extending from the support. The method can include providing an arm coupled with the base member at a second end of the base member, the arm extending from the base member to fit within an opening in a vessel. The method can also include providing a welding head coupled with the arm, the welding head to weld a welding interface at an interior surface of the vessel.

At least one aspect is directed to a method of welding a remote object. The method can include receiving, via an arm coupled with a base member, the arm extending from the base member to fit within an opening in a vessel, a metallic wire. The method can include receiving, via a welding head coupled with the arm, the metallic wire. The method can also include welding, via the metallic wire received at the welding head, a welding interface at an interior surface of the vessel.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example perspective view of a welding apparatus, in accordance with implementations.

FIG. 2 depicts an example side view of the welding apparatus of FIG. 1, in accordance with implementations.

FIG. 3 depicts an example side view of a portion of the welding apparatus of FIG. 1, in accordance with implementations.

FIG. 4 depicts an example rear view of a portion of the welding apparatus of FIG. 1, in accordance with implementations.

FIG. 5 depicts an example side view of a portion of the welding apparatus of FIG. 1, in accordance with implementations.

FIG. 6 depicts an example side view of a portion of the welding apparatus of FIG. 1, in accordance with implementations.

FIG. 7 depicts an example side view of a portion of the welding apparatus of FIG. 1, in accordance with implementations.

FIG. 8 depicts an example front view of a portion of the welding apparatus of FIG. 1, in accordance with implementations.

FIG. 9 depicts an example rear view of a portion of the welding apparatus of FIG. 1, in accordance with implementations.

FIG. 10 depicts an example perspective view of a portion of the welding apparatus of FIG. 1, in accordance with implementations.

FIG. 11 depicts an example side view of a portion of the welding apparatus of FIG. 1, in accordance with implementations.

FIG. 12 depicts an example side view of a portion of the welding apparatus of FIG. 1, in accordance with implementations.

FIG. 13 depicts an example side view of a portion of the welding apparatus of FIG. 1, in accordance with implementations.

FIG. 14 depicts an example rear view of the welding apparatus of FIG. 1, in accordance with implementations.

FIG. 15 depicts an example rear view of the welding apparatus of FIG. 1, in accordance with implementations.

FIG. 16 depicts an example illustration of a method, in accordance with implementations.

FIG. 17 depicts an example illustration of a method, in accordance with implementations.

FIG. 18 depicts an example illustration of a method, in accordance with implementations.

### DETAILED DESCRIPTION

Following below are more detailed descriptions of various concepts related to, and implementations of, methods, apparatuses, and systems of remote welding. The various concepts introduced above and discussed in greater detail below may be implemented in any of numerous ways.

The present disclosure is generally directed to an apparatus for remote welding of an interface at an interior surface of a weldment or an assembly, for example a vessel (e.g., an enclosure, a pipe, a duct, or another assembly with limited or restricted access). The process of welding an interior surface of a vessel (e.g., a pressure vessel) can include cutting an opening in a portion of the vessel, for example to provide a point of entry for a welder to enter the interior cavity of the vessel. After the welder has welded components of the vessel, the welder can exit the vessel, and the opening can be sealed or closed. However, the interior cavity of the vessel can be difficult for welders to access, it can be difficult to maneuver traditional welding devices within the confined cavity space, and the conditions in the interior of the vessel can make welding operations difficult (e.g., high temperatures, low visibility, poor air quality or ventilation, etc.). In order to capitalize on the advantages provided by remotely controllable welding and computing devices, the present application provides an apparatus that includes an arm to fit within an opening of a vessel, the arm having a computing device (e.g., camera) and a welding head to visualize and weld an interface at an interior surface of the vessel. This can, in turn, provide improved access to welding environments at interior surfaces of a vessel, offer increased visibility and maneuverability within the confined space inside the vessel, and offer remotely controlled welding operations to reduce risks associated with welders operating welding equipment within an interior cavity of a vessel.

The proposed solution can include a support and a base member coupled with the support, the base member extending from the support. The apparatus can also include an arm coupled with the base member, the arm extending from the base member to fit within an opening in a vessel, for example to provide access to a welding environment at the interior of a vessel. The apparatus can also include a welding head coupled with the arm, the welding head to weld a welding interface at an interior surface of the vessel. The arm can rotatably couple the base member and rotate about an axis relative to the base member, for example to provide increased maneuverability within a vessel. The apparatus can also include a computing device (e.g., camera) coupled with the arm to capture an image of a welding interface, for example to provide increased visibility to a welding environment at an interior of the vessel. The apparatus can further include a remote computing device communicably coupled with the welding head or the computing device, the remote computing device to control the welding head to weld the welding interface or the computing device to capture an image of the welding interface. For example, the apparatus offers remote control and visualization of the apparatus, to facilitate visualization, monitoring, or control of a welding operation at an interior surface of a vessel from a remote device.

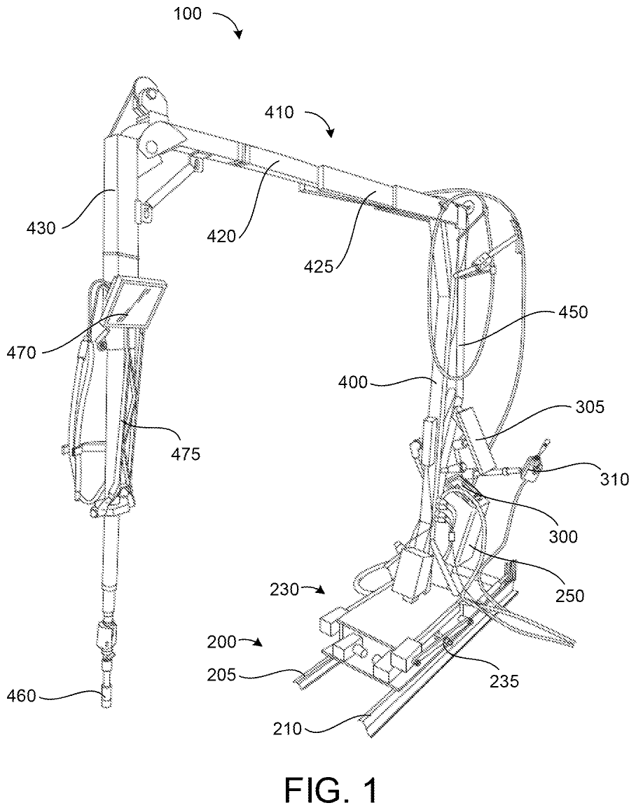

FIG. 1 depicts an example perspective view of a system for welding a weldment or an assembly, for example a vessel. The vessel can be a container, a reservoir, a chamber, or another structure having a cavity, for example to house a gas, a liquid, or another particle or matter. The vessel can be an enclosure, a pipe, a duct, or another assembly, for example an assembly with limited or restricted access. The system can weld one or more components of the vessel, for example during fabrication, maintenance, or repair of the vessel. The system can include one or more components to fit within an opening of the vessel, for example to facilitate welding an interface at an interior surface of the vessel. The system can also include one or more computing devices, for example to capture an image or visual representation of an interface of the vessel (e.g., while the interface is welded). One or more components of the system can be movable, for example to position or orient the system relative to the vessel. The system can also include one or more components that are coupled (e.g., removably coupled, movably coupled, slidably coupled, or otherwise coupled), for example for movement, replacement, or repair of one or more components the system. The system can further include a remote computing device communicably coupled with one or more components of the system, for example for remote control, monitoring, or maintenance of components of the system. As described herein, the system can be a welding apparatus.

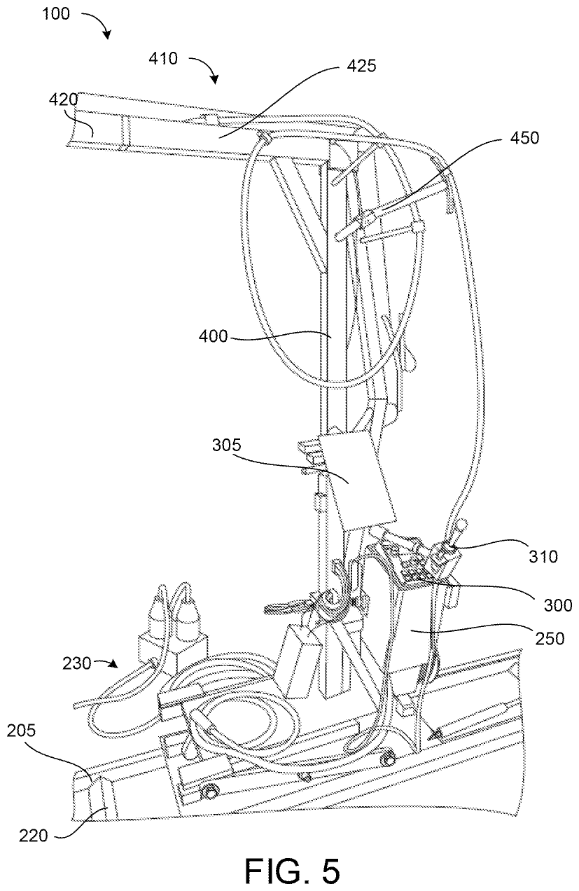

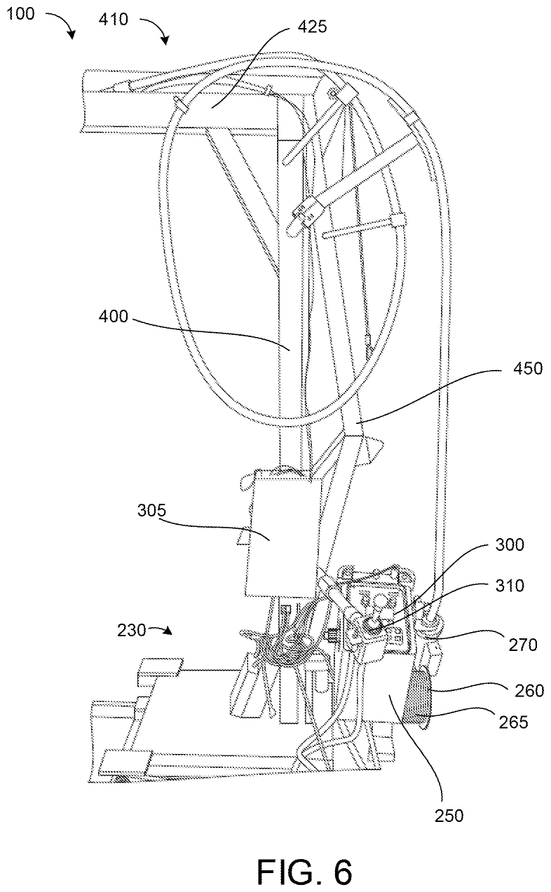

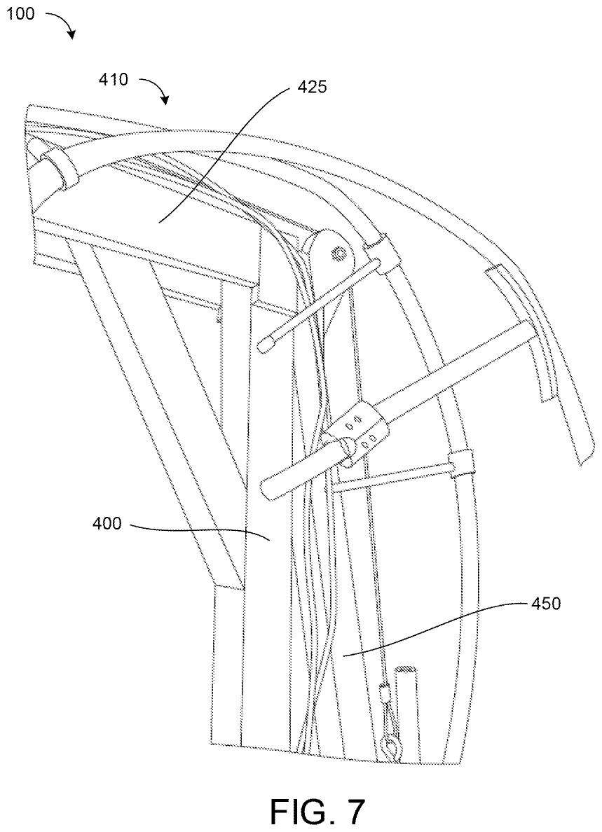

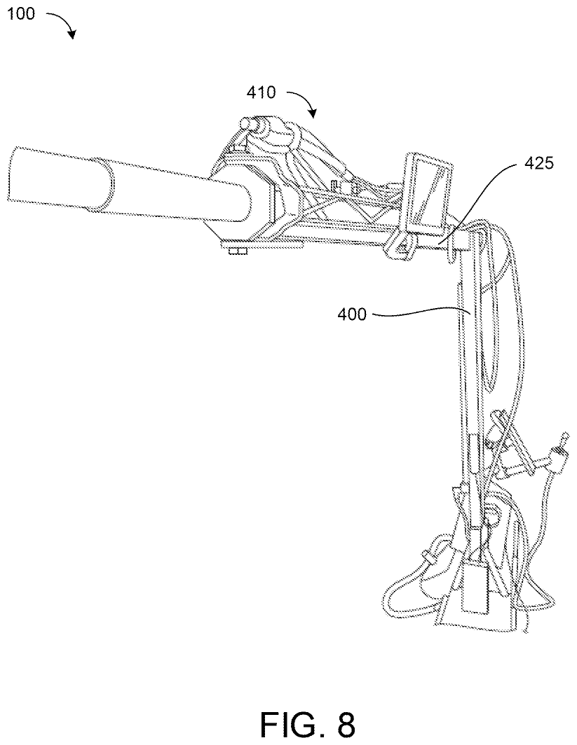

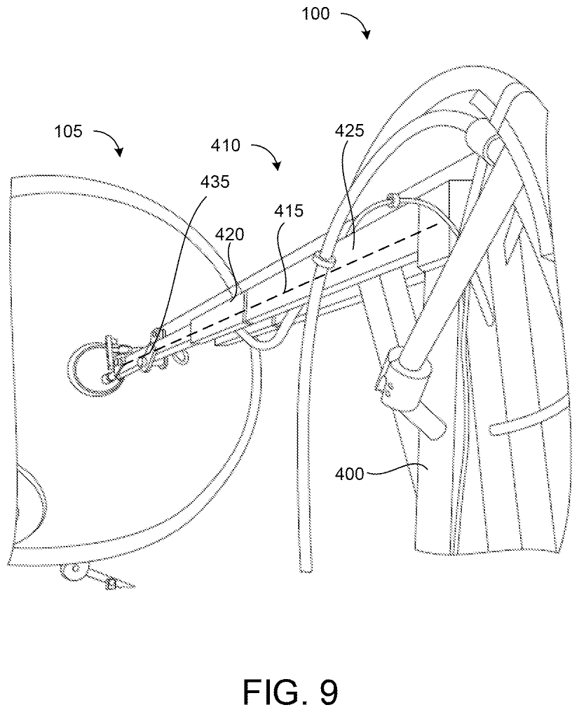

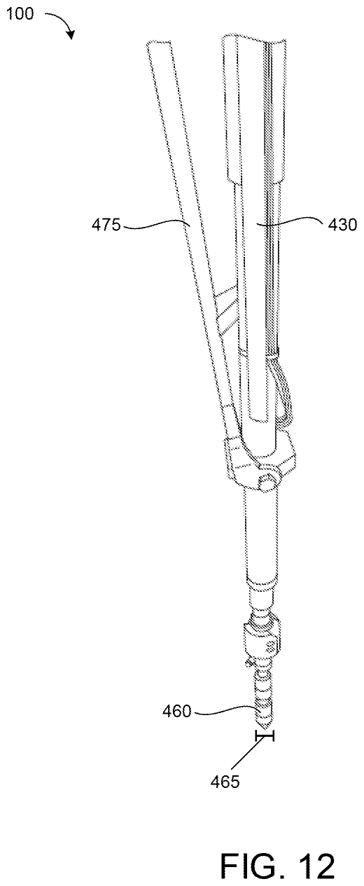

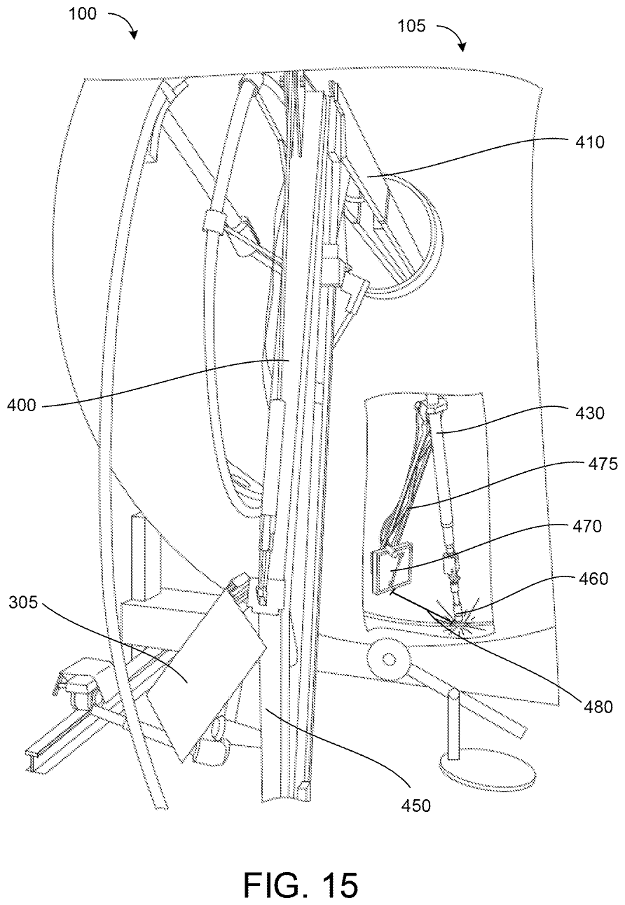

FIGS. 1-15, among others, depict example views of a welding apparatus 100 (hereinafter “apparatus 100”). The apparatus 100 can include components to weld at least one vessel 105 (depicted in at least FIGS. 9 and 14-15). For example, the apparatus 100 can include at least one welding head to weld a welding interface of the vessel 105. The apparatus 100 can include components to fit within an opening in the vessel 105, for example to facilitate welding an interior surface of the vessel 105 (depicted in at least FIG. 15). The apparatus 100 can also include at least one computing device to capture a visual representation of the apparatus 100 or vessel 105, for example to facilitate visualizing welding of an interior surface of the vessel 105 (depicted in at least FIG. 15). The apparatus 100 can include at least one remote computing device, for example to control components of the apparatus 100 or facilitate visualizing the apparatus 100 or the vessel 105 (e.g., during a welding operation).

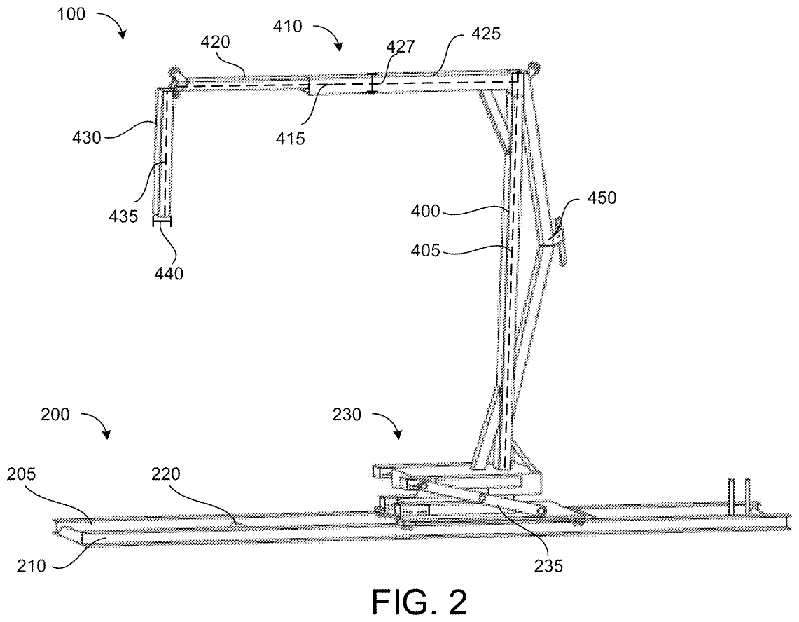

The apparatus 100 can include at least one foundation 200. The foundation 200 can be positioned on a support structure or surface (e.g., the ground), and can support, position, or orient one or more components of the apparatus 100. The foundation 200 can be in a fixed position or location, for example fixed relative to the vessel 105. The foundation 200 can be movable (e.g., transportable, repositionable), for example movable relative to the vessel 105. The foundation can include at least one rail, for example a first rail 205 or a second rail 210 (depicted in at least FIG. 2). The first rail 205 can be parallel with the second rail 210. For example, the first rail 205 and the second rail 210 can be parallel to provide a track for guiding one or more components of the apparatus 100. The first rail 205 or the second rail 210 can permit movement of components of the apparatus 100, for example sliding movement of components of the apparatus 100 (e.g., along an axis in a first or second direction). The foundation 200 (e.g., the first rail 205, the second rail 210) can also include at least one actuator 215 (not shown), for example to control movement (e.g., automatically, via control instructions) of components of the apparatus 100. The actuator 215 can propel components of the apparatus 100, for example to automatically position or orient components of the apparatus 100 (e.g., relative to the vessel 105). The foundation 200 (e.g., the first rail 205, the second rail 210) can also include at least one lock 220, for example to restrict or limit movement of components of the apparatus 100 (depicted in at least FIG. 2). The lock 220 can prevent movement of components of the apparatus 100, for example during a welding operation, or the lock 220 can restrain movement of components of the apparatus 100, for example during positioning or configuring the apparatus 100 in preparation for a welding operation.

The apparatus 100 can include at least one base 230. The base 230 can couple with the foundation 200, and can support, position, or orient one or more components of the apparatus 100. The base 230 can movably couple the foundation 200. For example, the base 230 can be movable along an axis of the foundation 200 (e.g., the first rail 205 or the second rail 210) in a first direction or a second direction. The base 230 can include at least one actuator, for example to control movement (e.g., automatically, via control decisions) of the base 230 relative to the foundation 200. The base 230 can also include at least one adjustment member 235 (depicted in at least FIG. 2). The adjustment member 235 can couple with a component of the base 230 (e.g., a top, bottom, front, back, lateral, or other component), and can be movable to reconfigure a size or orientation of the base 230. For example, the adjustment member 235 can expand or retract the base 230. The adjustment member 235 can expand the base 230 along an adjustment axis in a first direction, or retract the base 230 along the adjustment axis in a second direction. The adjustment axis can be misaligned (e.g., perpendicular or angled) with the longitudinal axis of the foundation 200 (e.g., the first rail 205 or the second rail 210), for example to facilitate vertical expansion or retraction of the base 230 along the adjustment axis, or horizontal movement of the base 230 along the longitudinal axis. The adjustment axis can be aligned with the longitudinal axis of the foundation 200 (e.g., the first rail 205, the second rail 210). The adjustment member 235 can include at least one actuator, for example to control (e.g., automatically, via control instructions) reconfiguring the base 230. The adjustment member 235 can be a component of a scissor lift, a jack-lift, or any other component to reconfigure the base 230. The adjustment member 235 can also be a single member (e.g., uniform), or the adjustment member 235 can include a plurality members (e.g., two, three, four, or any number of segmented members).

The apparatus 100 can include at least one power source 250. The power source 250 can couple with the base 230, and can provide energy to power components of the apparatus 100 (depicted in at least FIGS. 1, 3, and 5). For example, the power source 250 can provide energy from an energy storage device (e.g., batteries, capacitors) or from another power source (e.g., power grid). The power source 250 can also include a device that generates energy or power (e.g., a fuel cell, a solar panel, a generator having an internal combustion engine). The power source 250 can be electrically coupled with one or more components of the apparatus 100. For example, the power source 250 can electrically couple a welding head to provide energy to weld an interface of the vessel 105. The power source 250 can electrically couple a computing device to provide energy to the computing device, for example to capture a visual representation of the welding head or the vessel 105 (e.g., prior to or during a welding operating). The power source 250 can also electrically couple a welding spool or a feed tool, for example to facilitate unfurling or movement of a welding material to components of the apparatus 100 (e.g., to weld the vessel 105). The power source 250 can electrically couple a remote computing device, for example to facilitate controlling or monitoring components of the apparatus 100 (e.g., to weld or visualize the vessel 105).

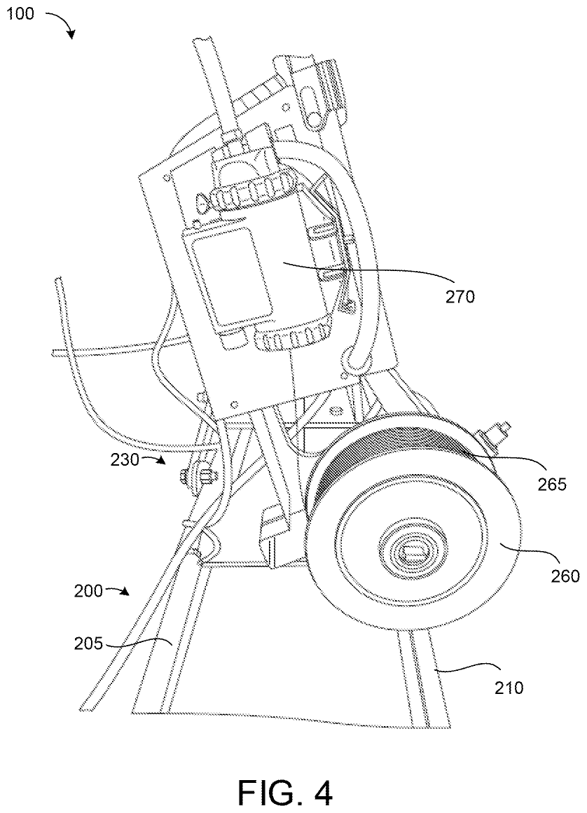

The apparatus 100 can include at least one welding spool 260. The welding spool 260 can couple the base 230, and can be wound with at least one welding material 265. For example, the welding spool 260 can rotatably couple the base 230, and the welding spool 260 can rotate to unfurl the welding material 265 from the welding spool 260. The welding spool 260 can couple with the base 230 in an alignment or configuration, for example the welding spool 260 can couple with the base 230 in a vertical configuration (depicted in at least FIG. 4). The welding spool 260 can unfurl the welding material 265 along a path, for example the welding spool 260 can unfurl the welding material 265 along a vertical path (e.g., misaligned with a longitudinal axis of the foundation 200). The welding spool 260 can be wound with a wire formed of the welding material 265, for example carbon steel, a ferrous alloy, a stainless steel (e.g., duplex stainless steel), titanium, steel, or another alloy suitable for welding. The welding spool 260 can also electrically couple the power source 250. For example, the welding spool 260 can electrically couple the power source 250, and receive energy or power from the power source 250 to control (e.g., automatically, via control decisions) unfurling of the welding material 265.

The apparatus 100 can include at least one feed tool 270. The feed tool 270 can couple with the base 230, and can facilitate movement of the welding material 265 to components of the apparatus 100. For example, the feed tool 270 can receive the welding material 265 from the welding spool 260, and can guide the welding material 265 to components of the apparatus 100 (e.g., a support, a base member, an arm, a welding head) to facilitate welding an interface of the vessel 105 (depicted in at least FIG. 4). The feed tool 270 can electrically couple the power source 250. For example, the feed tool 270 can electrically couple the power source 250, and can receive power from the power source 250 to control (e.g., automatically, via control decisions) movement of the welding material 265 from the welding spool 260 or to components of the apparatus 100 (e.g., a welding head). The feed tool 270 can couple with the base 230 in an alignment or configuration, for example the feed tool 270 can couple with the base in a vertical configuration (depicted in at least FIG. 4). The feed tool 270 can also receive the welding material 265 along a path, for example the feed tool can receive the welding material 265 from the welding spool 260 along a vertical path (e.g., misaligned with a longitudinal axis of the foundation 200).

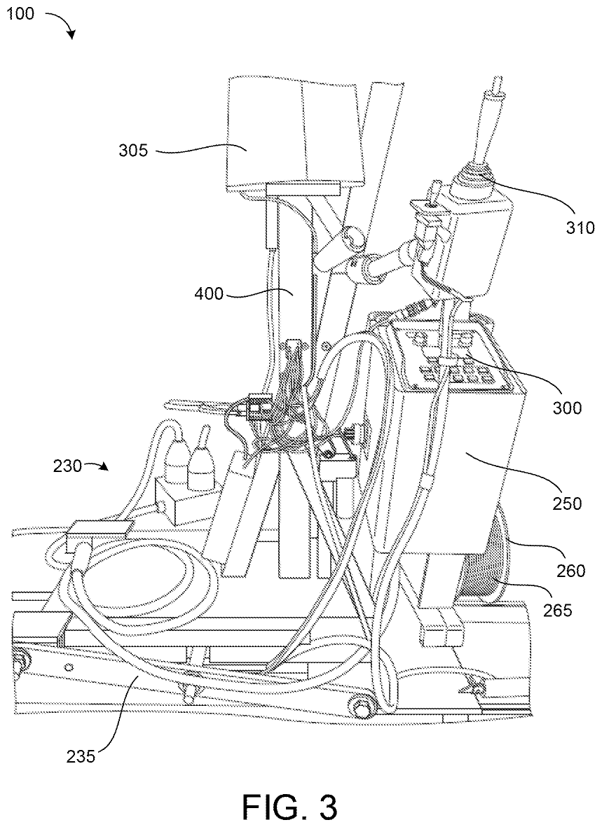

As depicted in at least FIGS. 1 and 3, the apparatus 100 can include at least one computing device 300. The computing device 300 can include, or be used to implement, a data processing system or its components. The computing device 300 can include at least one bus or other communication component for communicating information, and at least one processor or processing circuit coupled to the bus for processing information. The computing device 300 can also include one or more processors or processing circuits coupled to the bus for processing information. The computing device 300 can also include at least one main memory, such as a random access memory (RAM) or other dynamic storage device, coupled with the bus for storing information, and instructions to be executed by the processor. The main memory can be used for storing information during execution of instructions by the processor. The computing device 300 can further include at least one read only memory (ROM) or other static storage device coupled to the bus for storing static information and instructions for the processor. A storage device, such as a solid state device, magnetic disk or optical disk, can also be coupled with the bus to persistently store information and instructions.

The computing device 300 can be coupled with, or include, one or more displays 305 (depicted in at least FIGS. 1 and 3). For example, the display 305 can be a liquid crystal display, an active matrix display, or another suitable display for presenting information to a user. The display 305 can display one or more interfaces to a user, such as a welding operator of the apparatus 100 or another user. The display 305 can display information (e.g., via one or more interfaces) relating to the apparatus 100, for example a position, orientation, or operating condition of an arm or a welding head (e.g., before or during a welding operation of the vessel 105). The display 305 can also display diagnostic, maintenance, operating condition, operating parameter, operating threshold, component configuration, component threshold, component status, or other information relating to one or more components of the apparatus 100.

The computing device 300 can be coupled with, or include, an input device 310. For example, the input device 310 can be a joystick (as depicted in at least FIGS. 1 and 3) or an interactive interface (e.g., user interface, a touch screen display) for communicating information or commands to a processor of the computing device 300. The input device 310 can also be a keyboard, a voice interface, or another input computing apparatus for communicating information or commands to the processor. The input device 310 can include a cursor control, for example a joystick, a mouse, trackball, or cursor directional keys for communicating direction information or command selections to a processor of the computing device 300. For example, the input device 310 can include a cursor control (e.g., a joystick) for communicating direction or command controls to components of the apparatus 100 (e.g., the base 230, a support, a base member, an arm, a welding head, a computing device). The input device 310 can also include a command control for communicating commands (i.e. control decisions) to components of the apparatus 100. For example, the input device 310 can include a command control for controlling (e.g., via control decisions) operating conditions, operating configurations, operating settings, component conditions, component configurations, component settings, or other configuration or operating conditions of one or more components of the apparatus 100.

The processes, systems and methods described herein can be implemented by the computing device 300 in response to a processor executing an arrangement of instructions contained in a main memory. Such instructions can be read into main memory from another computer-readable medium, such as a storage device. Execution of the arrangement of instructions contained in main memory can cause the computing device 300 to perform the illustrative processes described herein. One or more processors in a multi-processing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing device 300 has been described herein, the subject matter including the operations described in this specification can be implemented in other types of digital electronic circuitry, or in computer software, firmware, or hardware, including the structures disclosed in this specification and their structural equivalents, or in combinations of one or more of them.

As depicted in at least FIGS. 1-2, the apparatus 100 can include at least one support 400. The support 400 can couple with the base 230, and the support 400 can support, position, or orient one or more components of the apparatus 100. The support 400 can extend from the base 230. For example, the support 400 can extend from the base 230 along a support axis 405 (depicted in at least FIG. 2). The support axis 405 can be misaligned with a support surface of the base 230, or the support axis 405 can be aligned with a support surface of the base 230. For example, the support axis 405 can be perpendicular to a support surface of the base 230, such that the support 400 extends vertically from the base 230 at a 90-degree angle. The support 400 can be or include a beam formed of metal. For example, the support 400 can be or include a hollow beam formed of aluminum. The support 400 can be or include another upright or support structure, or the support 400 can be formed of another suitable metal or material.

The support 400 can be uniform, or the support 400 can include one or more support segments. For example, the support 400 can include a first support segment coupled with a second support segment. The support 400 can include a first support segment movably coupled with a second support segment, for example to facilitate expansion or retraction of the support 400. The support 400 can be movably or rotatably coupled with the base 230. For example, the support 400 can movably couple the base 230, and the support 400 can translate along a surface of the base 230. The support 400 can rotatably couple the base 230, for example to rotate about an axis (e.g., the support axis 405) at the base 230. The support 400 can be pivotably coupled with the base 230, for example to pivot about a point at the base 230 (e.g., a point where the support 400 couples with the base 230).

The apparatus 100 can include at least one base member 410 (depicted in at least FIGS. 1-2). The base member 410 can couple with the support 400, and the base member 410 can support, position, or orient one or more components of the apparatus 100. For example, the base member 410 can couple with the support 400 at a first end of the base member 410, and can extend from the support 400. The base member 410 can extend from the support 400 along a base member axis 415 (depicted in at least FIG. 2). The base member axis 415 can be misaligned with (e.g., perpendicular to, angled with) the support axis 405 of the support 400. The base member axis 415 can be aligned with the support axis 405 of the support 400. The base member 410 can be or include a beam formed of metal, for example a support beam formed of aluminum. The base member 410 can be or include another support formed of another metal or suitable material. The base member 410 can be uniform, or can include one or more components. The base member 410 can be movably coupled with the support 400, for example to translate along the support 400 (e.g., along the support axis 405). The base member 410 can rotatably couple the support 400, for example to rotate about an axis (e.g., the base member axis 415) at the support 400, or the base member 410 can pivotably couple the support 400, for example to pivot about a point at the support (e.g., a point where the base member 410 couples with the support 400).

The base member 410 can be or include at least one first base component 420 or at least one second base component 425 (depicted in at least FIGS. 1-2). The first base component 420 can couple the second base component 425. For example, the first base component 420 can movably couple the second base component 425. The first base component 420 can extend from the second base component 425 along an axis (e.g., the base member axis 415), for example to an expanded configuration. The first base component 420 can retract toward the second base component 425 along an axis (e.g., the base member axis 415), for example to a retracted configuration. In the expanded configuration, the first base component 420 and the second base component 425 can define a first length. In the retracted configuration, the first base component 420 and the second base component 425 can define a second length. The first length and the second length can have a proportional relationship or configuration. For example, the first length and the second length can have a ratio of about 3:1. The first length and the second length can have another suitable ratio of about (e.g., within 10%) 2:1, 2.5:1, 3.5:1, 4:1, 5:1 or another ratio. The first base component 420 can rotatably couple the second base component 425. For example, the first base component 420 can rotatably couple the second base component 425, and the first base component 420 can rotate about an axis (e.g., the base member axis 415) relative to the second base component 425.

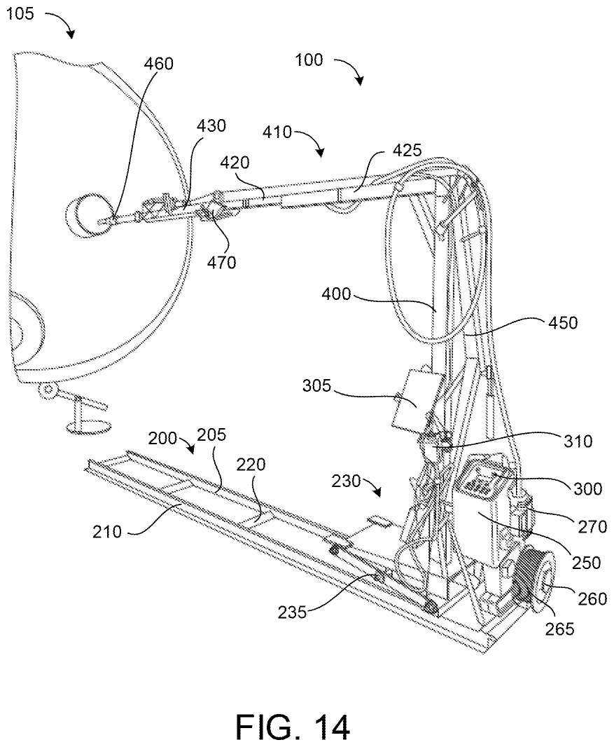

The base member 410 can have at least one cross-sectional dimension 427 (depicted in at least FIG. 2). The base member 410 can have a dimension 427, for example to fit within an opening in the vessel 105 (depicted in at least FIGS. 9 and 14). The dimension 427 can be a length, a width, or a height, for example when the base member 410 has a square or rectangular cross-sectional shape. The dimension 427 can be a diameter, a radius, or a circumference, for example when the base member 410 has a circular cross-sectional shape. The dimension 427 can be less than 5.5 inches, for example to fit within an opening in the vessel 105 having an 8-inch diameter. The dimension 427 can be less than 11 inches, for example to fit within an opening in the vessel 105 having a 16-inch diameter. The dimension 427 can be another dimension or measurement relating to a cross-sectional shape, or the dimension 427 can be another suitable size (e.g., 4, 5, 6, 10, 12, or another number of inches).

The apparatus 100 can include at least one arm 430 (depicted in at least FIGS. 1-2). The arm 430 can couple with the base member 410, and the arm 430 can support, position, or orient one or more components of the apparatus 100. For example, the arm 430 can couple with the base member 410 at a second end of the base member 410, and the arm 430 can extend from the base member 410. The arm 430 can extend from the base member 410 along an arm axis 435 (depicted in at least FIG. 2). The arm axis 435 can be misaligned with (e.g., perpendicular to, angled with) the base member axis 415 of the base member 410 (depicted in at least FIG. 2), for example in a welding configuration (e.g., during a welding operation). The arm axis 435 can be aligned with the base member axis 415 of the base member 410 (depicted in at least FIG. 9), for example in a positioning configuration (e.g., during movement or placement of the apparatus 100). The arm 430 can be or include a beam formed of metal, for example a support beam formed of aluminum. The arm 430 can be or include another support formed of another metal or suitable material. The arm 430 can be uniform, or can include one or more components (e.g., segments). For example, the arm 430 can include a first arm segment or a second arm segment that are movably coupled to facilitate expansion or retraction of the arm 430 (e.g., along the arm axis 435). The arm 430 can include a first arm segment or a second arm segment that are rotatably coupled, for example to facilitate rotation of an arm segment about an axis (e.g., a first arm segment about the arm axis 435). The arm 430 can include a first arm segment or a second arm segment that are pivotably coupled, for example to facilitate pivoting of an arm segment (e.g., a first arm segment) about a point (e.g., a point where a first arm segment couples a second arm segment).

The arm 430 can rotatably couple the base member 410 (depicted in at least FIGS. 1 and 9). For example, the arm 430 can rotatably couple the base member 410 to rotate the arm 430 about an axis, or translate the arm 430 within a plane. The arm 430 can rotatably couple the base member 410, and the arm 430 can rotate about an axis that is misaligned with an axis of the base member 410 (e.g., the base member axis 415). For example, the arm 430 can rotate about an axis that is perpendicular to the base member axis 415, or the arm 430 can translate within a plane that is aligned with the base member axis 415. For example, the arm 430 can translate within a plane that is aligned with the base member axis 415 to rotate between a welding configuration (depicted in at least FIGS. 1 and 15) and a positioning configuration (depicted in at least FIGS. 9 and 14). The arm 430 can rotatably couple the base member 410, and the arm 430 can rotate about an axis that is aligned with an axis of the base member 410 (e.g., the base member axis 415). For example, the arm 430 can rotate about an axis that is aligned with the base member axis 415, or the arm 430 can translate within a plane that is perpendicular to the base member axis 415. The arm 430 can rotate about an axis, or the arm 430 can translate within a plane, for example to facilitate welding an interface at a surface of the vessel 105.

The arm 430 can otherwise couple the base member 410. The arm 430 can pivotably couple the base member 410 to pivot about a point at the base member 410. For example, the arm 430 can pivotably couple the base member 410 at a second end of the base member 410. The arm 430 can pivot about a point at the second end of the base member 410, for example to provide 360 degrees of movement of the arm 430 within a plane. The arm 430 can pivot about a point at a second end of the base member 410, for example to provide another amount of movement of the arm 430 within a plane (e.g., 45, 90, 120, 180 or another number of degrees). The arm 430 can movably couple the base member 410, for example to translate the arm 430 along the base member 410 (e.g., along the base member axis 415). The arm 430 can be rotatably, pivotably, or movably coupled to the base member 410, for example to provide flexible configurations or orientations of the arm 430 (e.g., or a welding head) to facilitate positioning the apparatus 100 or welding an interface of the vessel 105.

The arm 430 can have at least one cross-sectional dimension 440 (depicted in at least FIG. 2). The arm 430 can have the dimension 440, for example to fit within an opening in the vessel 105 (depicted in at least FIGS. 9 and 14). The dimension 440 can be a length, a width, or a height, for example when the arm 430 has a square or rectangular cross-sectional shape. The dimension 440 can be a diameter, a radius, or a circumference, for example when the arm 430 has a circular cross-sectional shape. The dimension 440 can be less than 5.5 inches, for example to fit within an opening in the vessel 105 having an 8-inch diameter. The dimension 440 can be less than 11 inches, for example to fit within an opening in the vessel 105 having a 16-inch diameter. The dimension 440 can be another dimension or measurement relating to a cross-sectional shape, or the dimension 440 can be another suitable size (e.g., 4, 5, 6, 10, 12, or another number of inches).

The support 400, the base member 410, or the arm 430 can be formed of a metal (e.g., aluminum or another metal), for example to reduce the overall weight of the apparatus 100. The support 400, the base member 410, or the arm 430 can have a hollow configuration, for example to house or support one or more electrical components (e.g., electrical cords, wires, power cables), actuators (e.g., motors), or other welding materials or components (e.g., the welding material 265, a gas lines or channels). The support 400, the base member 410, or the arm 430 can be removably coupled, for example to provide a modular configuration that can facilitate repositioning, transporting, or replacing components of the apparatus 100. The support 400, the base member 410, or the arm 430 can have dimensions (e.g., longitudinal lengths). For example, the support 400 can have a dimension (e.g., a length) of about (e.g., within 10%) 72 inches, the base member 410 can have a dimension (e.g., a length in the retracted configuration, a length in the expanded configuration) of about (e.g., within 10%) 76 inches, or the arm 430 can have a dimension (e.g., a length) of about (e.g., within 10%) 60 inches. The support 400, the base member 410, or the arm 430 can have dimensions (e.g., longitudinal lengths) that have a proportional relationship. For example, the support 400, the base member 410 (e.g., in the retracted configuration), and the arm 430 can have proportional dimensions having a ratio of 2:2:1. The support 400, the base member 410 (e.g., in the retracted configuration), and the arm 430 can have proportional dimensions having a ratio of 2:4:1. The support 400, the base member 410, and the arm 430 can have proportional dimensions having another ratio, for example about (e.g., within 10%) 2:2.5:1, 2.5:2:1, 2:5:1, or another suitable ratio.

The support 400, the base member 410, or the arm 430 can have dimensions having a proportional relationship with another component of the apparatus 100. For example, the arm 430 and the support 400 can have proportional dimensions having a ratio of 1:1.25, or another suitable ratio (e.g., 1:1, 1:1.3, 1:1.5, 1:2, or another suitable ratio). The foundation 200 (e.g., the first rail 205, the second rail 210) can also have a dimension (e.g., longitudinal length). The base member 410 and the foundation 200 can have a proportional relationship. For example, the base member 410 and the foundation 200 (e.g., the first rail 205, the second rail 210) can have proportional dimensions having a ratio of 1:2.5, or another suitable ratio (e.g., 1:1, 1:1.5, 1:1.75, 1:2, 1:3, or another suitable ratio).

The apparatus 100 can include at least one tuner 450 (depicted in at least FIG. 2). The tuner 450 can be coupled with the support 400, the base member 410, or the arm 430, and the tuner 450 can facilitate modifying or adjusting the position or configuration of one or more components of the apparatus 100. For example, the tuner 450 can couple the support 400 (e.g., a first support segment, a second support segment), for example to modify or adjust a vertical orientation of the support 400. The tuner 450 can couple the base member 410. For example, the tuner 450 can couple the first base component 420 and the second base component 425. The tuner 450 can modify or adjust the position of the first base component 420 relative to the second base component 425, for example to move the base member 410 between the retracted configuration and the expanded configuration. The tuner 450 can also couple the arm 430 to modify or adjust the position of the arm 430. For example, the tuner 450 modify or adjust the position of the arm 430, such that the arm axis 435 is perpendicular to the base member axis 415 (e.g., in a welding configuration, as depicted in at least FIG. 1) or the arm axis 435 is aligned with the base member axis 415 (e.g., in a positioning configuration, as depicted in at least FIG. 9). The tuner 450 can be a lever or catch (depicted in at least FIG. 2), for example to allow a user to manually modify or alter the position or configuration of the support 400, the base member 410, or the arm 430. The tuner 450 can also be an actuator (e.g., motor), for example to mechanically control (e.g., automatically, via control decisions) the position or configuration of the support 400, the base member 410, or the arm 430. The tuner 450 can also couple with other components of the apparatus 100, for example a welding head, a computing device, or another component. The tuner 450 can modify, adjust, or control other components of the apparatus 100. For example, the tuner 450 can adjust, modify, or control the position or orientation of a welding head, a computing device (e.g., camera), or other components of the apparatus 100.

The apparatus 100 can include at least one welding head 460 (depicted in at least FIGS. 1, and 10-11). The welding head 460 can couple with the arm 430, and the welding head 460 can weld one or more structures at an interface. For example, the welding head 460 can couple with an end of the arm 430, and can weld an interface at an interior surface of the vessel 105 (depicted in at least FIG. 15). The welding head 460 can include at least one welding component, for example a gas tube or channel, a gas diffuser, a conductor cable or tube, a heat source, a contact tip, or another component for welding. The welding head 460 can receive one or more welding materials from components of the apparatus 100. For example, the welding head 460 can receive the welding material 265 via the arm 430 (e.g., via the base member 410, the support 400, the feed tool 270, and the welding spool 260), a gas via a gas channel or tube, or energy or power (e.g., via the power source 250) to power the welding head 460. The welding head 460 can be a wand, for example to perform gas metal arc welding. The welding head 460 can be another configuration for performing another style of welding, for example gas tungsten arc welding, flux-cored arc welding, shielded-metal arc welding, laser beam welding, plasma arc welding, submerged arc welding, or another suitable style of welding.

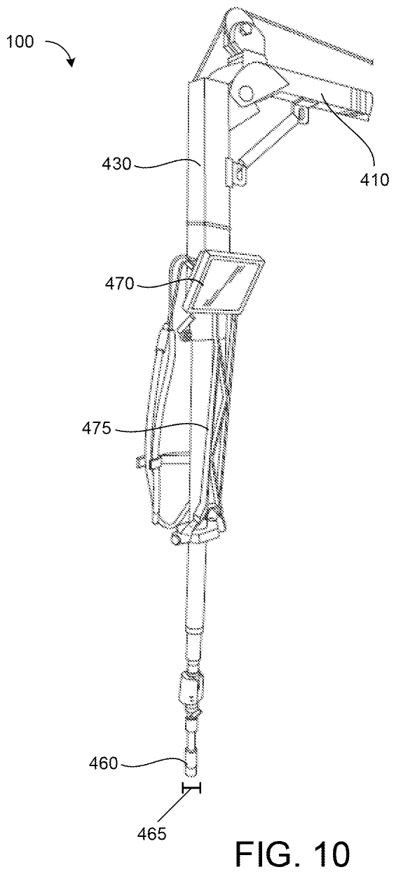

The welding head 460 can have a cross-sectional dimension 465 (depicted in at least FIGS. 10-12). The welding head 460 can have a dimension 465, for example to fit within an opening in the vessel 105 (depicted in at least FIGS. 9 and 14). The dimension 465 can be a diameter, a radius, or a circumference, for example when the welding head 460 has a circular cross-sectional shape. The dimension 465 can be a length, a width, or a height, for example when the welding head 460 has a square or rectangular cross-sectional shape. The dimension 465 can be less than 5.5 inches, for example to fit within an opening in the vessel 105 having an 8-inch diameter. The dimension 465 can be less than 11 inches, for example to fit within an opening in the vessel 105 having a 16-inch diameter. The dimension 465 can be another dimension or measurement relating to a cross-sectional shape, or the dimension 465 can be another suitable size (e.g., 4, 5, 6, 10, 12, or another number of inches).

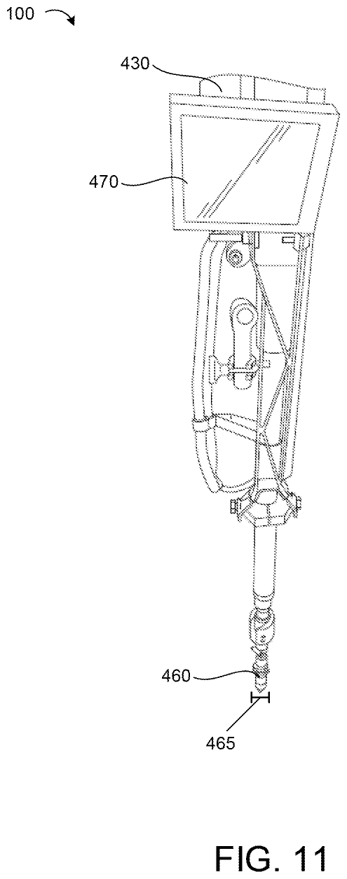

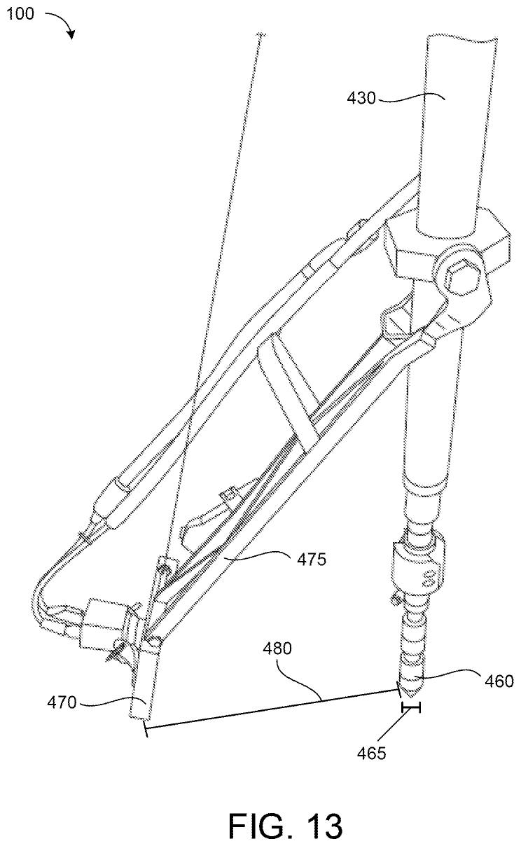

The apparatus 100 can include at least one computing device 470 (depicted in at least FIGS. 1, and 10-13). The computing device 470 can be coupled with the arm 430, and the computing device 470 can facilitate an exchange of information with a user or other components of the apparatus 100 (e.g., the computing device 300). The computing device 470 can couple with the arm 430, and extend from the arm 430 via an extension member 475. The computing device 470 can rotatably couple the arm 430, for example to rotate the computing device 470 about an axis. The computing device 470 can rotate about an axis that is misaligned with the arm axis 435. For example, the computing device 470 can rotate about an axis that is perpendicular with the arm axis 435. The computing device 470 can translate between a position adjacent to the arm 430 (e.g., a positioning configuration, as depicted in at least FIGS. 10-11) and a position adjacent to the welding head 460 (e.g., a welding configuration, as depicted in at least FIG. 13). The computing device 470 can be positioned adjacent to the arm 430 (as depicted in at least FIGS. 10-11), for example to facilitate repositioning or moving the arm 430 or computing device 470 within an opening in the vessel 105. The computing device 470 can also be repositioned (e.g., unfurled) to a position a distance 480 from the welding head 460 (depicted in at least FIG. 13), for example to capture information or data during a welding operation. The distance 480 can be 12 inches, or another suitable distance (e.g., 3, 6, 10, 18, 24, 36, or another number of inches). The computing device 470 can otherwise be coupled with the arm 430, for example movably or pivotably coupled to facilitate translation or pivoting of the computing device 470 at the arm 430.

The computing device 470 can include hardware or associated logic for facilitating the exchange of information, for example to a user or another component of the apparatus 100. The computing device 470 can be or include a camera or imaging device. For example, the computing device 470 can be or include a camera or imaging device to capture a visual representation (e.g., image, video) of an interface, the welding head 460, or the vessel 105. The computing device 470 can capture a visual representation (e.g., image, video) of an interface at an interior surface of the vessel 105, for example during a welding operation. The computing device 470 can communicate information captured by the computing device (e.g., visual representations, images, videos) to one or more remote computing devices. For example, the computing device 470 can communicate the captured information or data to the computing device 300, and the computing device 300 can display the information to a welding operator or user via the display 305. The computing device 470 can facilitate visualizing, monitoring, or controlling conditions or configurations of a welding operation. For example, the computing device 470 can facilitate real-time visualization or monitoring of a welding interface or the welding head 460 (e.g., before or during a welding operation), which can be used to control components of the apparatus 100 (e.g., the welding head 460, the arm 430) to perform the welding operation.

The computing device 470 can also include one or more sensors or feedback devices, for example a temperature or heat sensor to monitor a temperature or thermal output at an interface or the welding head 460. The computing device 470 can also include additional components or devices, for example an auto-darkening lens, an infrared filter, an ultraviolet filter, a stabilization device (e.g., a screen stabilization device), a light-emitting diode, semiconductor, or other components of devices. The components of the computing device 470 can facilitate visualizing or monitoring an interface, the welding head 460, or the vessel 105, for example to provide quality control information relating to a welding operation. For example, a light emitting diode or other lighting device of the computing device 470 can provide (e.g., generate) light to illuminate an interface, the welding head 460, or the vessel 105 to facilitate visualization of a welding operation. The computing device 470 can include one or more imaging devices, for example to capture a visual representation of a welding operation from one or more angles (e.g., two, three, four, or another number of angles) or to provide a visual representation of a welding operation at one or more dimensions (e.g., to facilitate three-dimensional visualization).

The apparatus 100 can also include one or more additional components to facilitate performance of a welding operation. For example, the apparatus 100 can include a reservoir coupled with the base 230 or the support 400, for example to house a gas or another material to facilitate a welding operation (e.g., argon, helium, carbon dioxide, oxygen, hydrogen, nitrogen, acetylene, or another gas or material). The apparatus 100 can include a channel or tube coupled with the reservoir or the welding head 460 (e.g., via the support 400, the base member 410, the arm 430), for example to facilitate movement of a material from the reservoir to the welding head 460. The apparatus 100 can include one or more control valves or meters, for example to modulate movement of a material (e.g., gas), energy or power, the welding material 265, or another component or material of the apparatus 100. The apparatus 100 can include a flux hopper to house or control a rate of deposition of flux, or liquid reservoir to house or control a rate of disposition of a liquid (e.g., a water cooler), for example to facilitate a gas tungsten arc welding, submerged arc welding, or plasma arc welding operation. The apparatus 100 can also include a cutting head for cutting one or more materials, for example to facilitate a plasma welding or oxy-fuel torch welding or cutting operation.

FIGS. 9 and 14 depict the apparatus 100 in a positioning configuration. The apparatus 100 can be positioned relative to the vessel 105. For example, the foundation 200 can be positioned relative to the vessel 105 (e.g., fixed, movable to a position or location), and the base 230 can couple the foundation 200. The base 230 can be positioned along the foundation 200 (e.g., via an actuator, automatically, via control decisions, via input from the computing device 300), for example to facilitate movement of the arm 430. The tuner 450 can modify or adjust the position or orientation of components of the apparatus 100. For example, the tuner 450 can modify or adjust the position of the arm 430 (e.g., rotate the arm 430). The tuner 450 can modify the position of the arm 430 (e.g., rotate the arm 430), such that the arm axis 435 is aligned with the base member axis 415. The arm 430 and the base member 410 can extend along the same axis (e.g., the arm axis 435, the base member axis 415), for example to straighten the arm 430 and the base member 410 (depicted in at least FIGS. 9 and 14). The computing device 300 can communicate commands or control instructions to components of the apparatus 100 (e.g., the arm 430), for example to remotely modify or adjust the position or orientation of the arm 430.

The apparatus 100 can be positioned relative to the vessel 105, for example to position one or more components of the apparatus 100 within the vessel 105. The base 230 can be movable along the foundation 200 (e.g., along an axis toward the vessel 105), for example to reposition the arm 430 or the base member 410 within an opening in the vessel 105. The tuner 450 can modify or adjust the position or orientation of components of the apparatus 100, for example the base member 410. The tuner 450 can move the first base component 420 relative to the second base component 425, for example to reconfigure the base member 410 to an expanded configuration. The tuner 450 can move the first base component 420 to reposition the arm 430 or the base member 410 (e.g., the first base component 420) within an opening in the vessel 105. The computing device 300 can communicate commands or control instructions to components of the apparatus 100. For example, the computing device 300 can communicate control commands to the base 230, for example to move the base 230 along the foundation 200. The computing device 300 can communicate control commands to the base member 410, for example to move the first base component 420 relative to the second base component 425 to reconfigure the base member 410 to an expanded configuration. The computing device 300 can communicate control commands to the base 230, the base member 410, or other components of the apparatus 100 (e.g., the foundation 200, one or more actuators), for example to reposition the arm 430 or the base member 410 within an opening in the vessel 105.

FIGS. 1 and 15 depict the apparatus 100 in a welding configuration. For example, the arm 430 and the base member 410 can be positioned within the vessel 105 (e.g., via an opening in the vessel 105). With the arm 430 or the base member 410 within the vessel 105, the tuner 450 can modify or adjust the position or orientation of components of the apparatus 100. For example, the tuner 450 can modify or adjust the position of the arm 430 (e.g., rotate the arm 430). The tuner 450 can modify the position of the arm 430 (e.g., rotate the arm 430), such that the arm axis 435 is misaligned with the base member axis 415. For example, the tuner 450 can position the arm 430 so the arm axis 435 is perpendicular to the base member axis 415. The computing device 300 can communicate commands or control instructions to components of the apparatus 100 (e.g., the arm 430). For example, the computing device 300 can communicate control instructions to the arm 430 to remotely adjust the position of the arm 430, such that the arm axis 435 is misaligned with (e.g., perpendicular to) the base member axis 415.

The apparatus 100 can be positioned relative to the vessel 105, for example to position one or more components of the apparatus 100 adjacent to an interface of the vessel 105 (e.g., at an interior surface of the vessel 105). For example, the tuner 450 can modify the position or orientation of the arm 430 (e.g., move the arm 430), for example to expand or retract the arm 430 to position the arm 430 adjacent to an interior surface of the vessel 105. The tuner 450 can modify the position or orientation of the arm 430, for example to position the welding head 460 to interface with (e.g., engage, contact, or otherwise interact with) an interior surface of the vessel 105 (depicted in at least FIG. 15). The computing device 300 can communicate control instructions to the arm 430, for example to remotely expand or retract the arm 430 to position the welding head 460 to interface with an interior surface of the vessel 105.

The tuner 450 can also modify or adjust the position of the computing device 470. For example, the tuner 450 can modify the position of the computing device (e.g., rotate the computing device 470), such that the computing device 470 is positioned a distance (e.g., the distance 480) from the welding head 460 (e.g., and the interior surface of the vessel 105). With the welding head 460 positioned to interface with an interior surface of the vessel 105, or the computing device 470 positioned the distance 480 from the welding head 460, the welding head 460 can weld an interior surface of the vessel 105 (depicted in at least FIG. 15). For example, the welding head 460 can receive the welding material 265 (e.g., via the feed tool 270 from the welding spool 260), and can weld an interior surface of the vessel 105. The computing device 470 can information or data, and can communicate the information and data to a user or device (e.g., the computing device 300). For example, the computing device 470 can capture a visual representation (e.g., image, video) of the welding environment (e.g., the interface, the welding head 460, the vessel 105), and can communicate the visual representation to the computing device 300 to be displayed on the display 305. During the welding operation, the tuner 450 can modify or adjust the position or orientation of the arm 430, the welding head 460, or the computing device 470, for example in response to monitoring or visualizing the welding environment. The computing device 300 can communicate control commands to components of the apparatus 100, for example to position the computing device 470, capture or communicate information or data relating to the welding environment, or control the arm 430, the welding head 460, or the computing device 470 to perform a welding operation.

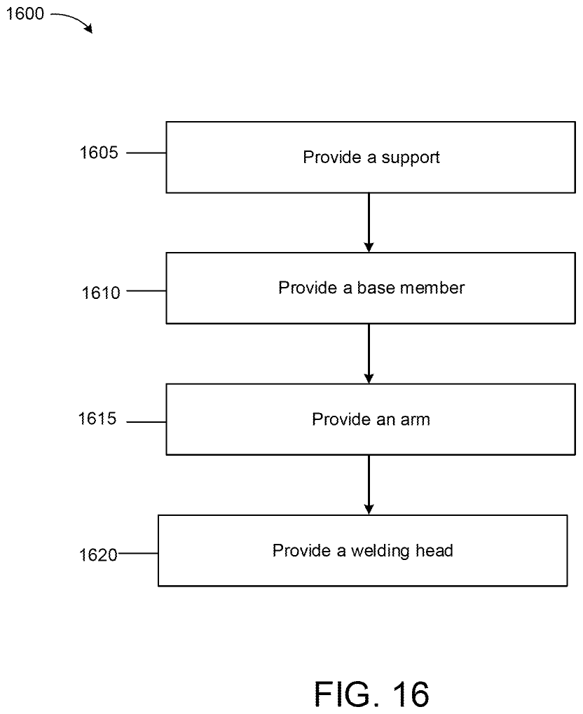

FIG. 16 depicts an illustration of a method 1600. The method can include one or more ACTS 1605-1620. The method 1600 can include providing a support, as depicted at ACT 1605. For example, the support 400 can couple with the base 230, and support, position, or orient one or more components of the apparatus 100. The support 400 can extend from the base 230 along the support axis 405, for example in a direction misaligned with (e.g., perpendicular to) a support surface of the base 230. The support 400 can be uniform or include one or more support segments. For example, the support 400 can include a first support segment coupled with a second support segment, the first support segment movably or rotatably coupled with the second support segment (e.g., to facilitate expansion/retraction or rotation of the support segments). The support 400 can couple the base 230, for example movably or rotatably couple the base 230 (e.g., to facilitate translation or rotation at the base 230).

The method 1600 can include providing a base member 410, depicted at ACT 1610. For example, the base member 410 can couple the support 400, and can support, position, or orient one or more components of the apparatus 100. The base member 410 can couple the support 400 at a first end of the base member 410. The base member 410 can extend from the support 400, for example along the base member axis 415. The base member axis 415 can be misaligned with the support axis 405 or aligned with the support axis 405. The base member 410 can couple the support 400, for example movably couple, rotatably couple, or pivotably couple. For example, the base member 410 can movably couple the support 400 to facilitate translation of the base member 410 along the support 400 (e.g., the support axis 405). The base member 410 can rotatably couple the support 400, for example to facilitate rotation of the base member 410 about an axis (e.g., the base member axis 415).

The base member 410 can include the first base component 420 or the second base component 425. The first base component 420 can couple the second base component 425. For example, the first base component 420 can movably couple the second base component 425. The first base component 420 can extend from the second base component 425 to an expanded configuration, and the first base component 420 can retract toward the second base component 425 to a retracted configuration. The first base component 420 and the second base component 425 can define a first length in the expanded configuration, and a second length in the retracted configuration. The first length and the second length can have a proportional relationship, for example the first length and the second length can have a ratio of 3:1, or another suitable ratio (e.g. 2:1, 2.5:1, 3.5:1, 4:1, 5:1 or another ratio).

The base member 410 can have a cross-sectional dimension, for example the dimension 427. The base member 410 can have the dimension 427, for example to fit within an opening in the vessel 105. The dimension 427 can be a length, a width, or a height (e.g., if the base member 410 has a square or rectangular cross-sectional shape), or the dimension 427 can be a diameter, a radius, or a circumference (e.g., if the base member 410 has a circular cross-sectional shape). The dimension 427 can be less than 5.5 inches, for example to fit within an opening in the vessel 105 having an 8-inch diameter. The dimension 427 can be another suitable size (e.g., 4, 5, 6, 10, 12, or another number of inches).

The method 1600 can include providing an arm 430, depicted at ACT 1615. For example, the arm 430 can couple the base member 410, and can support, position, or orient one or more components of the apparatus 100. The arm 430 can couple the base member 410 at a second end of the base member 410. The arm 430 can extend from the base member 410, for example along an arm axis 435. The arm axis 435 can be misaligned with the base member axis 415 (e.g., in a welding configuration) or aligned with the base member axis 415 (e.g., in a positioning configuration). The arm 430 can be uniform or can include one or more components or segments. For example, the arm 430 can include a first arm segment coupled with a second arm segment. The first arm segment can movably or rotatably couple the second arm segment, for example to facilitate expansion/retraction or rotation of the first arm segment relative to the second arm segment.

The arm 430 can have a cross-sectional dimension, for example the dimension 440. The arm 430 can have the dimension 440, for example to fit within an opening in the vessel 105. The dimension 440 can be a length, a width, or a height (e.g., if the arm 430 has a square or rectangular cross-sectional shape), or the dimension 440 can be a diameter, a radius, or a circumference (e.g., if the arm 430 has a circular cross-sectional shape). The dimension 440 can be less than 5.5 inches, for example to fit within an opening in the vessel 105 having an 8-inch diameter. The dimension 440 can be another suitable size (e.g., 4, 5, 6, 10, 12, or another number of inches).

The arm 430 can rotatably couple the base member 410. For example, the arm 430 can rotatably couple the base member 410 to rotate the arm about an axis or translate the arm 430 within a plane. The arm 430 can rotate about an axis that is misaligned with (e.g., perpendicular to) the base member axis 415, for example to translate the arm within a plane that is aligned with the base member axis 415. The arm 430 can rotate about an axis that is aligned with (e.g., parallel to, coaxial with) the base member axis 415, for example to translate the arm within a plane that is perpendicular to the base member axis 415. The arm 430 can otherwise couple the base member 410. For example, the arm 430 can pivotably couple the base member 410 to pivot about a point at the base member 410 (e.g., a point at a second end of the base member 410). The arm 430 can movably couple the base member 410, for example to translate the arm 430 along the base member 410 (e.g., along the base member axis 415).

The support 400, the base member 410, or the arm 430 can be formed of a metal or another suitable material. The support 400, the base member 410, or the arm 430 can be removably coupled, for example to provide a modular configuration. The support 400, the base member 410, or the arm 430 can have proportional dimensions. For example, the support 400, the base member 410, and the arm 430 can have proportional dimensions having a ratio of 2:2:1, or another suitable ratio (e.g., 2:2.5:1, 2.5:2:1, 2:4:1, 2:5:1, or another suitable ratio).

The method 1600 can include providing a welding head 460, depicted at ACT 1620. The welding head 460 can couple the arm 430, and can weld one or more structures at an interface. For example, the welding head 460 can couple an end of the arm 430, and can weld an interface at an interior surface of the vessel 105. The welding head 460 can include at least one welding component (e.g., a conductor cable or tube, a heat source, a contact tip, or another component for welding), or can receive one or more welding materials (e.g., the welding material 265, gas, energy or power) to facilitate welding a surface of the vessel 105.

The welding head 460 can have a cross-sectional dimension 465. The welding head 460 can have the dimension 465, for example to fit within an opening in the vessel 105. The dimension 465 can be a length, a width, or a height (e.g., if the welding head 460 has a square or rectangular cross-sectional shape), or the dimension 465 can be a diameter, a radius, or a circumference (e.g., if the welding head 460 has a circular cross-sectional shape). The dimension 465 can be less than 5.5 inches, for example to fit within an opening in the vessel 105 having an 8-inch diameter. The dimension 465 can be another suitable size (e.g., 4, 5, 6, 10, 12, or another number of inches).

The method 1600 can include providing a computing device 470. The computing device 470 can couple the arm 430, and can facilitate the exchange of information with a user or other components of the apparatus 100. For example, the computing device 470 can couple the arm 430 and extend from the arm via the extension member 475. The computing device 470 can rotatably couple the arm 430, and can rotate about an axis to position the computing device 470 relative to the arm 430 (e.g., the welding head 460). The computing device 470 can rotate about an axis that is misaligned with an axis of the arm 430 (e.g., the arm axis 435) or an axis that is aligned with an axis of the arm 430 (e.g., the arm axis 435). The computing device 470 can be or include a camera or imaging device to capture a visual representation (e.g., image, video). For example, the computing device 470 can capture a visual representation of an interface at an interior surface of the vessel 105, the welding head 460, or the vessel 105 (e.g., before or during a welding operation). The visual representation of the interface can provide information or data relating to the conditions of a welding environment at an interior surface of the vessel 105. The computing device 470 can communicate the capture information or data to the computing device 300, and the computing device 300 can display the information to a welding operator or a user via the display 305.

The method can include providing a remote computing device, for example the computing device 300. The computing device can communicably couple components of the apparatus 100. The computing device 300 can communicate commands or control instructions to components of the apparatus 100, for example to control one or more configurations or operations. For example, the computing device 300 can communicably couple the base member 410 or the arm 430. The computing device 300 can communicate commands or control instructions to control the position or orientation of the base member 410 or the arm 430. The computing device 300 can also communicably couple the welding head 460 or the computing device 470. The computing device 300 can communicably couple the welding head 460, for example to communicate commands or control instructions to control operation of the welding head 460 (e.g., during a welding operation, prior to a welding operation). The computing device 300 can communicably couple the computing device 470, for example to control the position or orientation of the computing device 470, or to instruct the computing device 470 to capture information (e.g., a visual representation) relating to a welding environment. The computing device 300 can also include the display 305, for example to display information relating to the apparatus 100 or a welding operation to a welding operator or user.

The method can include providing the base 230. The base 230 can couple the foundation 200 or the support 400, and can support, position, or orient one or more components of the apparatus 100. The base 230 can movably couple the foundation 200, for example to facilitate movement of the base 230 along an axis (e.g., a longitudinal axis of the foundation 200) in a first direction or a second direction. The base 230 can include the adjustment member 235, for example to reconfigure a size or orientation of the base 230. For example, the base 230 can expand or retract along an adjustment axis (e.g., a vertical axis).

The method can include providing the welding spool 260. The welding spool 260 can couple the base 230, and can be wound with the welding material 265. The welding spool can rotatably couple the base 230, for example to rotate to unfurl the welding material 265 from the welding spool 260. The welding spool 260 can couple the base 230 in an alignment or configuration, for example in a vertical configuration. The method can also include providing the feed tool 270. The feed tool 270 can couple the base 230, and can facilitate movement of the welding material 265 to components of the apparatus 100. For example, the feed tool 270 can receive the welding material 265 from the welding spool 260, and can guide the welding material 265 to the welding head 460. The feed tool 270 can also guide the welding material 265 to the support 400, the base member 410, or the arm 430. The feed tool 270 can couple the base 230 in an alignment or configuration, for example in a vertical configuration. The welding spool 260 or the feed tool 270 can communicably couple the power source 250, for example to receive power from the power source 250.

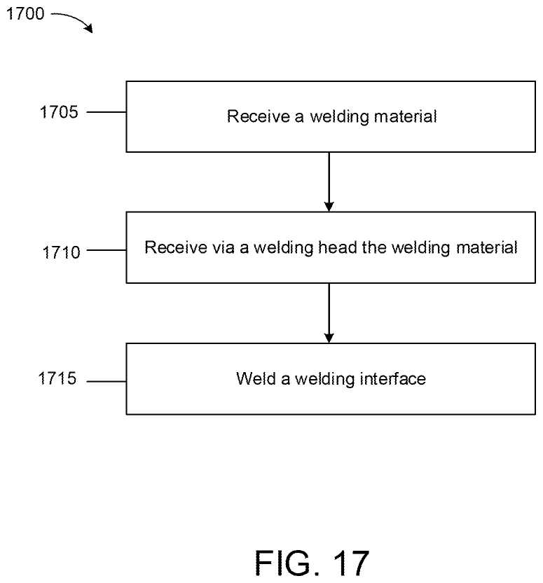

FIG. 17 depicts an illustration of a method 1700. The method 1700 can include one or more ACTS 1705-1715. The method 1700 can include receiving a welding material 265, as depicted at ACT 1705. The welding material 265 can be a metallic wire. The metallic wire can be wound around the welding spool 260. The welding spool 260 can unfurl the welding material 265, and the welding material 265 can be received by the feed tool 270. The feed tool 270 can facilitate movement of the welding material 265 to components of the apparatus 100. For example, the feed tool 270 can facilitate movement of the welding material 265, such that the welding material 265 is received at the arm 430 via the base member 410. The arm 430 or the base member 410 can have a cross-sectional dimension, for example for the arm 430 or the base member 410 to fit within an opening in the vessel 105. The feed tool 270 can control movement of the welding material 265, for example to have the welding material received at the support 400 or another component of the apparatus 100.

The method 1700 can include receiving, via the welding head 460, the welding material 265, as depicted at ACT 1710. The welding head 460 can couple the arm 430, for example the welding head 460 can couple an end of the arm 430. The feed tool 270 can facilitate movement of the welding material 265 to components of the apparatus 100. For example, the feed tool 270 can facilitate movement of the welding material 265, such that the welding material 265 is received at the welding head 460. The feed tool 270 can facilitate movement of the welding material 265, such that the welding material 265 is received at the arm 430, the base member 410, or the support 400, for example from the welding spool 260.

The method 1700 can include welding a welding interface, as depicted at ACT 1715. The welding interface can be at an interior surface of the vessel 105. The welding head 460 can receive the welding material 265, and the welding head 460 can weld an interface at an interior surface of the vessel 105. The welding head 460 can weld the interface using the welding material 265. The welding head 460 can weld the interface via a gas metal arc welding style, or another style of welding (e.g., gas tungsten arc welding, flux-cored arc welding, shielded-metal arc welding, laser beam welding, plasma arc welding, submerged arc welding, atomic hydrogen welding, electroslag, or another suitable style of welding).

The method 1700 can include capturing information or data. For example, the computing device 470 can capture information (e.g., a visual representation) relating to a welding environment. The computing device 470 can capture information relating to a position or orientation of the welding head 460 relative to an interior surface of the vessel 105, one or more conditions of an interface (e.g., a welding interface) at an interior surface of the vessel 105, or other information relating to a welding environment. The method can include displaying the information or data. For example, the computing device 470 can communicate the captured information (e.g., the visual representation) relating to the welding environment to a user or other computing device (e.g., the computing device 300). The computing device 300 can receive the information relating to the welding environment, and display the information via the display 305. For example, the computing device 300 (e.g., via the display 305) can provide real-time images or video of the welding environment relayed from the computing device 470.

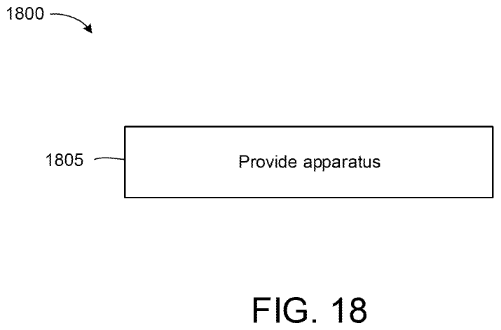

FIG. 18 depicts an illustration of a method 1800. The method 1800 can include providing the apparatus 100, as described at ACT 1805. The apparatus 100 can include the support 400. The apparatus 100 can also include the base member 410. The base member 410 can couple the support 400 at a first end of the base member 410. The base member 410 can extend from the support 400, for example along the base member axis 415. The apparatus 100 can also include the arm 430. The arm 430 can couple with the base member 410 at a second end of the base member 410. The arm 430 can extend from the base member 410, for example along an arm axis 435. The arm 430 can have the dimension 440 (e.g., a cross-sectional dimension), for example to fit within an opening in the vessel 105. The apparatus 100 can also include the welding head 460. The welding head 460 can couple with the arm 430, for example an end of the arm 430. The welding head 460 can weld an interface of the vessel 105. For example, the welding head 460 can weld an interface at an interior surface of the vessel 105.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. References to top or bottom, or other orientations, can indicate positioning when the apparatus 100 is in an orientation such as a welding configuration within the vessel 105.

Other substitutions, modifications, changes and omissions can also be made in the design, operating conditions and arrangement of the disclosed elements and operations without departing from the scope of the present disclosure. For example, the apparatus 100 can include several welding heads 460 or computing devices 470 that weld or provide information related to a an interface at a surface of the vessel 105. Elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A welding apparatus, comprising:
a support;
a base member coupled with the support at a first end of the base member, the base member extending from the support;
an arm coupled with the base member at a second end of the base member, the arm extending from the base member to fit within an opening in a vessel; and
a welding head coupled with the arm, the welding head to weld a welding interface at an interior surface of the vessel.

2. The apparatus of claim 1, comprising:
the arm rotatably coupled with the base member, the arm to rotate about an axis that is misaligned with a longitudinal axis of the base member to weld the welding interface of the vessel.

3. The apparatus of claim 1, comprising:
the arm rotatably coupled with the base member, the arm to rotate about an axis that is aligned with a longitudinal axis of the base member.

4. The apparatus of claim 1, comprising:
the welding head having a cross-sectional dimension of less than 8 inches, the welding head to fit within the opening in the vessel.

5. The apparatus of claim 1, comprising:
a computing device coupled with the arm, the computing device to capture an image of the welding interface while the welding head is welding the welding interface.

6. The apparatus of claim 1, comprising:
a computing device rotatably coupled with the arm, the computing device to ratable about an axis that is misaligned with a longitudinal axis of the arm to capture an image of the welding interface.

7. The apparatus of claim 1, comprising:
the base member having a first component and a second component, the first component movably coupled with the second component, the first component to extend from the second component along a longitudinal axis of the base member in a first direction and the first component to retract toward the second component along the longitudinal axis of the base member in a second direction.

8. The apparatus of claim 1, comprising:
the base member to move between an expanded position and a retracted position, the base member having a first length in the expanded position and the base member having a second length in the retracted position, the first length and the second length having a ratio of 3:1.

9. The apparatus of claim 1, comprising:
the arm having a cross-sectional dimension of less than 8 inches, the arm to fit within the opening of the vessel.

10. The apparatus of claim 1, comprising:
a base coupled with the support, the base movable in a first direction along a first axis and movable in a second direction along a second axis, the first axis misaligned with the second axis.

11. The apparatus of claim 1, comprising:
a remote computing device communicably coupled with a computing device, the remote computing device to display an image of the welding interface captured by the computing device.

12. The apparatus of claim 1, comprising:
a remote computing device communicably coupled with the welding head, the remote computing device to control the welding head to weld the welding interface.

13. The apparatus of claim 1, comprising:
a remote computing device communicably coupled with the arm, the remote computing device to control a movement of the arm about an axis that is misaligned with a longitudinal axis of the base member.

14. The apparatus of claim 1, comprising:
a feeder coupled with the support, the feeder to control a movement of a metallic wire through the support and to the welding head to control a rate of welding the welding interface.

15. The apparatus of claim 1, comprising:
a spool would with a metallic wire coupled with the support, the spool to facilitate movement of the metallic wire through the support to the welding head.

16. A method of welding a remote object, comprising:
providing a support;
providing a base member coupled with the support at a first end of the base member, the base member extending from the support;
providing an arm coupled with the base member at a second end of the base member, the arm extending from the base member to fit within an opening in a vessel; and
providing a welding head coupled with the arm, the welding head to weld a welding interface at an interior surface of the vessel.

17. The method of claim 16, comprising:
providing the arm coupled with the base member, the arm to rotate about an axis that is misaligned with a longitudinal axis of the base member.

18. The method of claim 16, comprising:
providing a computing device, the computing device coupled with the arm, the computing device to capture an image of the welding interface while the welding head is welding the welding interface.

19. The method of claim 16, comprising:
providing the arm, the arm having a cross-sectional dimension of less than 8 inches, the arm to fit within the opening of the vessel.

20. A method of welding a remote object, comprising:
receiving, via an arm coupled with a base member, the arm extending from the base member to fit within an opening in a vessel, a metallic wire;
receiving, via a welding head coupled with the arm, the metallic wire; and
welding, via the metallic wire received at the welding head, a welding interface at an interior surface of the vessel.
